(19) United States
(12) Patent Application Publication
(10) Pub. No.: US 2020/0334044 A1
(43) Pub. Date: Oct. 22, 2020

(54) INFORMATION PROCESSING SYSTEM AND POWER SUPPLY CONTROL METHOD

(71) Applicant: FUJITSU CLIENT COMPUTING LIMITED, Kanagawa (JP)

(72) Inventor: Akira Takeuchi, Kawasaki (JP)

(73) Assignee: FUJITSU CLIENT COMPUTING LIMITED, Kanagawa (JP)

(21) Appl. No.: 16/816,913

(22) Filed: Mar. 12, 2020

(30) Foreign Application Priority Data
Apr. 16, 2019 (JP) 2019-077563

(51) Int. Cl. G06F 9/4401; G06F 9/50; G06F 1/3209; G06F 1/3287; H04W 52/02

(52) U.S. Cl. CPC G06F 9/442; G06F 9/5027; H04W 52/0229; G06F 1/3287; G06F 1/3209

(57) ABSTRACT

An information processing system includes: a plurality of information processing devices; and a relay device that includes a plurality of buses to which the information processing devices are connected. The relay device requests a main information processing device among the information processing devices to execute a shutdown once the relay device receives an operation of forcibly shutting down the information processing system, the shutdown being requested on a condition that a power state of the main information processing device is activated. The main information processing device shuts down the main information processing device once the main information processing device receives the request for the shutdown.

### CROSS-REFERENCE TO RELATED APPLICATIONS

This application is based upon and claims the benefit of priority from Japanese Patent Application No. 2019-077563, filed Apr. 16, 2019, the entire contents of which are incorporated herein by reference.

### TECHNICAL FIELD

Embodiments described herein relate to an information processing system and a power supply control method.

### BACKGROUND

Conventionally, a method of parallel computation using a plurality of information processing devices has been known. For example, an information processing system has been proposed, which exchanges data between information processing devices over Ethernet (registered trademark) lines.

Such an information processing system employs a method for forcibly shutting down by keeping a power button holding down in addition to a method for normally shutting down.

However, when an attempt is made to forcibly shut down by keeping the power button holding down after inputting an operation of executing a normal shutdown, the holding down of the power button may be erroneously detected as a power-on operation. In this case, there arises a problem that a power state of each device in the information processing system may be different.

### SUMMARY

An information processing system according to one aspect of the present disclosure includes: a plurality of information processing devices; and a relay device including a plurality of buses to which the plurality of information processing devices are connected. The relay device is configured to request a main information processing device in the plurality of information processing devices to execute a shutdown when the relay device receives an operation of forcibly shutting down the information processing system, the shutdown being requested on a condition that a power state of the main information processing device is activated. The main information processing device is configured to shut down the main information processing device when the main information processing device receives the request for the shutdown.

A power supply control method according to another aspect of the present disclosure is implemented by a distributed computer in which a plurality of information processing devices are connected to a relay device over a plurality of buses. The method includes: requesting, from the relay device, a main information processing device in the plurality of information processing devices to execute a shutdown when the relay device receives an operation of forcibly shutting down the distributed computer, the shutdown being requested on a condition that a power state of the main information processing device is activated; and shutting down the main information processing device when the main information processing device receives the request for the shutdown.

### BRIEF DESCRIPTION OF THE DRAWINGS

FIG. 1 is a diagram illustrating an example of an overall configuration of a distributed computer according to an embodiment;

FIG. 2 is a diagram illustrating an example of a power supply configuration of the distributed computer according to the embodiment;

FIG. 3 is a timing chart illustrating an example of power supply control processing for a case where a forcible shutdown operation is received;

FIG. 4 is a timing chart illustrating an example of power supply control processing for a case where a forcible shutdown operation is received after shutdown processing is started by a shutdown operation of pushing a power button;

FIG. 5 is a timing chart illustrating an example of power supply control processing for a case where a forcible shutdown operation is received after shutdown processing is started by a shutdown operation received on an OS screen;

FIG. 6 is a timing chart illustrating an example of power supply control for a case where a forcible shutdown operation is received before shutdown processing by a shutdown operation of pushing a power button is started;

FIG. 7 is a timing chart illustrating an example of power supply control processing for a case where a forcible shutdown operation is received before shutdown processing by a shutdown operation received on an OS screen is started;

FIG. 8 is a timing chart illustrating an example of power supply control for a case where a forcible shutdown operation is received after starting up a distributed computer;

FIG. 9 is a timing chart illustrating an example of power supply control processing for a case where a forcible shutdown operation is received after a startup operation of a distributed computer and before a platform (main) is activated; and

FIG. 10 is a timing chart illustrating an example of power supply control processing for a case where a forcible shutdown operation is received after a startup operation of a distributed computer and before a platform (sub) is activated.

### DETAILED DESCRIPTION

An information processing system and a power supply control method according to the present disclosure are capable of advantageously preventing a power state of each information processing device from being different.

Embodiments of an information processing system and a power supply control method according to the present disclosure will be described below in detail with reference to the drawings. The present disclosure is not limited to the following embodiments.

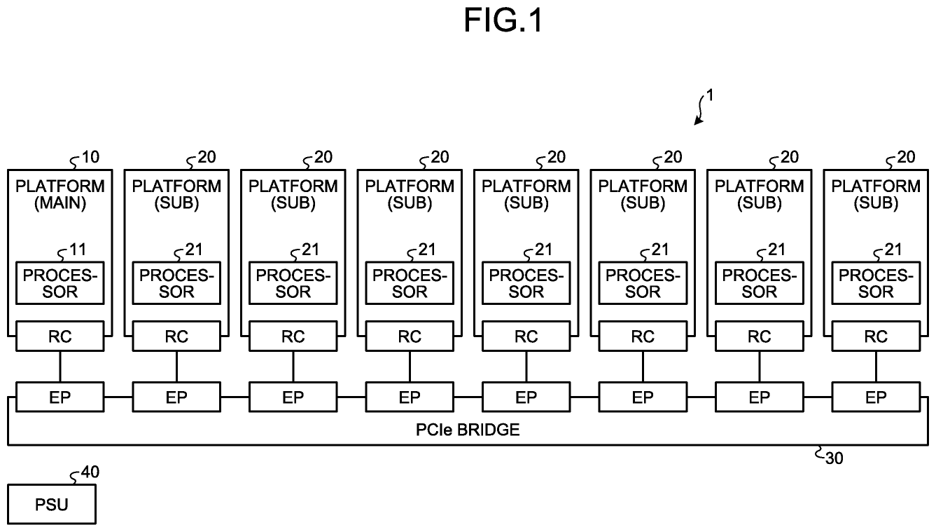

FIG. 1 is a diagram illustrating an example of an overall configuration of a distributed computer 1 according to the embodiment. As illustrated in FIG. 1, the distributed computer 1 according to the embodiment is an information processing system that includes a platform (main) 10, a plurality of platforms (sub) 20, and a Peripheral Component Interconnect Express (PCIe; registered trademark) bridge 30 having a plurality of buses to which the platform (main) 10 and the platforms (sub) 20 are connected. The distributed computer 1 is capable of controlling a power state of the platform (main) 10 and the plurality of platforms (sub) 20. Furthermore, the distributed computer 1 includes a power supply unit (PSU) 40 that supplies power to each section of the distributed computer 1.

The platform (main) 10 and the plurality of platforms (sub) 20 are communicably connected over the PCIe bridge 30. The platform (main) 10 and the plurality of platforms (sub) 20 may be, for example, inserted into slots on a board on which the PCIe bridge 30 is provided. Any of the slots may be in an empty state where nodes are not inserted.

The platform (main) 10 is a main information processing device that manages the platforms (sub) 20 and causes the platforms (sub) 20 to execute various types of processing. The platform (main) 10 includes a processor 11.

The processor 11 controls the entire platform (main) 10. The processor 11 may be a multiprocessor. The processor 11 may be, for example, any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). Further, the processor 11 may be a combination of two or more of the CPU, the MPU, the GPU, the DSP, the ASIC, the PLD, and the FPGA.

Each platform (sub) 20 is a sub information processing device that executes, based on a request from the platform (main) 10, artificial intelligence (AI) inference processing and image processing, for example.

The platforms (sub) 20 each include a processor 21. The processors 21 included in the platforms (sub) 20 may have different architectures. Further, the processors 21 may be provided from different manufacturers or may be provided from an identical manufacturer.

Each processor 21 controls the corresponding platforms (sub) 20. The processor 21 may be a multiprocessor. The processor 21 may be any one of the CPU, the MPU, the GPU, the DSP, the ASIC, the PLD, and the FPGA, for example. Further, the processor 11 may be a combination of two or more of the CPU, the MPU, the GPU, the DSP, the ASIC, the PLD, and the FPGA.

In addition, the processor 11 of the platform (main) 10 and the processor 21 of the platform (sub) 20 each serve as an operable root complex (RC) on a host side. A device mounted on the PCIe bridge 30 serves as an endpoint (EP), and data transfer is executed between the hosts and the device.

Further, the PCIe bridge 30 controls an interconnect bus provided in the bridge 30 to execute data transfer between the EPs. The PCIe bridge 30 is a relay device that relays communication between the platform (main) 10 and the platform (sub) 20 and between the platform (sub) 20 and the platform (sub) 20.

The PSU 40 supplies power to each section of the distributed computer 1. That is, the PSU 40 supplies power to the platform (main) 10, the platforms (sub) 20, and the PCIe bridge 30.

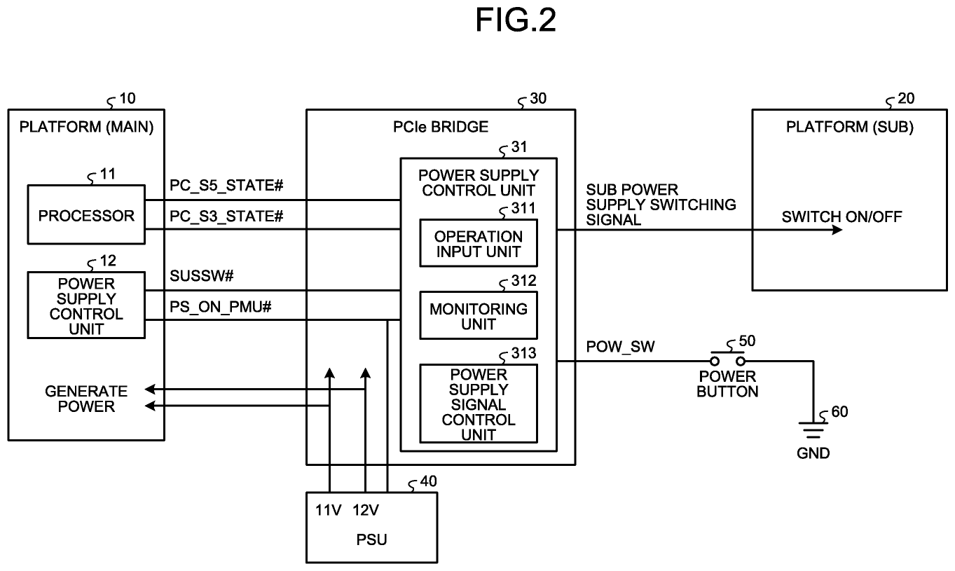

Next, power supply control in the distributed computer 1 will be described. FIG. 2 is a diagram illustrating an example of a power supply configuration of the distributed computer 1 according to the embodiment.

The distributed computer 1 includes a power button 50 that receives an operation of changing a power state of the distributed computer 1. The power button 50 is an operation unit that receives operations of starting up, shutting down, and forcibly shutting down the distributed computer 1. The power button 50 receives, as an operation of starting up the distributed computer 1, an operation of pushing the power button 50 in a shutdown state of the distributed computer 1. In addition, the power button 50 receives, as an operation of shutting down the distributed computer 1, an operation of pushing the power button 50 in an activated state of the distributed computer 1. Furthermore, the power button 50 receives, as an operation of forcibly shutting down the distributed computer 1, an operation of keeping power button 50 holding down for a predetermined period of time in the activated state of the distributed computer 1. The predetermined period of time is, for example, four seconds but may be arbitrarily changed.

Further, the distributed computer 1 may receive an operation of shutting down the distributed computer 1 not by the power button 50 but by other methods. For example, the distributed computer 1 may receive an operation of shutting down the distributed computer 1 on an operating system (OS) screen of the platform (main) 10.

The PCIe bridge 30 includes a power supply control unit 31 that controls a power supply of the distributed computer 1. The power supply control unit 31 is an example of a first power supply control unit. The power supply control unit 31 is, for example, a microcomputer.

The power supply control unit 31 may be any one of the CPU, the MPU, the GPU, the DSP, the ASIC, the PLD, and the FPGA, instead of the microcomputer. The power supply control unit 31 may also be a combination of two or more of the CPU, the MPU, the GPU, the DSP, the ASIC, the PLD, and the FPGA.

The PCIe bridge 30 transmits and receives various signals. More specifically, the PCIe bridge 30 transmits and receives signals such as a POW_SW signal, a PC_S5_STATE # signal, a PC_S3_STATE # signal, a SUSSW # signal, a sub power supply switching signal, and a PS_ON_PMU # signal. A 12V and an 11V are connected to the PCIe bridge 30. The POW_SW signal, the PC_S5_STATE # signal, the PC_S3_STATE # signal, the SUSSW # signal, the sub power supply switching signal, and the PS_ON_PMU # signal are transmitted to and received from the power supply control unit 31.

The POW_SW signal is a power supply operation signal representing an operation received by the power button 50. More specifically, the POW_SW signal is connected to a GND 60 via the power button 50. Therefore, when the power button 50 is pushed, the POW_SW signal becomes in a Low state. On the other hand, when the power button 50 is not pushed, the POW_SW signal is in a High state.

The PC_S5_STATE # signal is a power state signal representing a power state of the platform (main) 10. More specifically, the PC_S5_STATE # signal represents the power state of the platform (main) 10 that can be either in a shutdown state or in an activated state. The PC_S5_STATE # signal signifies that the platform (main) 10 is in the shutdown state when this signal is in a High state. On the other hand, the PC_S5_STATE # signal signifies that the platform (main) 10 is in the activated state when this signal is in a Low state. Specifically, the PC_S5_STATE # signal being in the High state represents a G3 state of an advanced configuration and power interface (ACPI). On the other hand, the PC_S5_STATE # signal being in the Low state represents each of the states of S0 to S5 of the ACPI.

The PC_S3_STATE # signal is a dormant state signal representing whether or not the platform (main) 10 is in a dormant state (hibernation). More specifically, the PC_S3_STATE # signal represents the power state of the platform (main) 10 which can be either in the dormant state or in the activated state. The PC_S3_STATE # signal signifies that the platform (main) 10 is in the dormant state when this signal is in a High state. On the other hand, the PC_S3_STATE # signal signifies that the platform (main) 10 is in the activated state when this signal is in a Low state. Specifically, the PC_S3_STATE # signal being in the High state represents the state of S5 of the ACPI. On the other hand, the PC_S5_STATE # signal being in the Low state represents each of the states of S0 to S4 of the ACPI.

The SUSSW # signal is a power supply control signal that is used for switching between activation and shutdown of the platform (main) 10. More specifically, the platform (main) 10 activates the platform (main) 10 itself when a falling edge of the SUSSW # signal is detected in the activated state. On the other hand, the platform (main) forcibly shuts down the platform (main) 10 itself when a Low state of the SUSSW # signal is detected for a predetermined period of time in the shutdown state.

The sub power supply switching signal is a signal used for switching the power states of the platforms (sub) 20. More specifically, the sub power supply switching signal is used for switching between ON/OFF states of a power supply of each platform (sub) 20. The platform (sub) 20 enters the ON state when the sub power supply switching signal is in a High state. On the other hand, the platform (sub) 20 enters the OFF state when the sub power supply switching signal is in a Low state.

The PS_ON_PMU # signal is a signal used for switching supply of a 12V power. More specifically, the PSU 40 supplies the 12V power when the PS_ON_PMU # signal is in a Low state. On the other hand, the PSU 40 shuts off the supply of the 12V power when the PS_ON_PMU # signal is in a High state.

The 12V is a power supply that supplies 12V of power. The 11V is a power supply that supplies 11V of power. By using the 11V power supply, the platform (main) can execute processing of switching between activation and shutdown, but cannot execute high-load processing.

The power supply control unit 31 implements functions illustrated in FIG. 2 through execution of a software program stored in a memory (not illustrated) of the power supply control unit 31 by a hardware processor (not illustrated) such as the CPU or the MPU. The power supply control unit 31 includes an operation input unit 311, a monitoring unit 312, and a power supply signal control unit 313.

The operation input unit 311 receives a POW_SW signal that represents an operation received by the power button 50. When the POW_SW signal enters the Low state for, for example, four seconds or more, the operation input unit 311 determines that an operation of forcibly shutting down the distributed computer 1 is input.

The monitoring unit 312 monitors the PC_S5_STATE # representing the power state of the platform (main) 10. More specifically, the monitoring unit 312 monitors the PC_S5_STATE # that is obtained when a falling edge of the POW_SW signal is detected. When the falling edge of the POW_SW signal is detected, the monitoring unit 312 determines, based on the PC_S5_STATE #, that the platform (main) 10 is in the activated state or in the shutdown state.

When the POW_SW signal is valid for a predetermined period of time, it is determined that a forcible shutdown has been input. At that time, on a condition that the PC_S5_STATE # signifies that the platform (main) 10 is activated, the power supply signal control unit 313 requests a shutdown by switching a state of the SUSSW # signal used for causing the platform (main) 10 to shut down.

More specifically, when the POW_SW signal enters the Low state for four seconds or more, the operation input unit 311 determines that the operation of forcibly shutting down the distributed computer 1 has been input. At that time, the monitoring unit 312 determines, based on the PC_S5_STATE #, that the platform (main) 10 is in the activated state or in the shutdown state. When the monitoring unit 312 determines that the platform (main) 10 is in the activated state, the power supply signal control unit 313 sets the SUSSW # signal to keep it in the Low state for a predetermined period of time in order to shut down the platform (main) 10. The predetermined period of time is, for example, five seconds but may be arbitrarily changed. On the other hand, when the monitoring unit 312 determines that the platform (main) 10 is in the shutdown state, the power supply signal control unit 313 maintains a High state of the SUSSW # signal.

With such a configuration, when receiving an operation of forcibly shutting down the distributed computer 1, the power supply control unit 31 requests, on a condition that the power state of the platform (main) 10 is activated, a shutdown of the platform (main) 10. In addition, when the forcible shutdown operation is received after receiving an operation of shutting down the distributed computer 1, the power supply control unit 31 requests, on a condition that the power state of the platform (main) 10 is activated, a shutdown of the platform (main) 10. Moreover, when the forcible shutdown operation is received after receiving an operation of starting up the distributed computer 1, the power supply control unit 31 requests, on a condition that the power state of the platform (main) is activated, a shutdown of the platform (main) 10.

The platform (main) 10 is provided with a power supply control unit 12. The power supply control unit 12 is a microcomputer, for example.

Instead of the microcomputer, the power supply control unit 12 may be any one of the CPU, the MPU, the GPU, the DSP, the ASIC, the PLD, and the FPGA, for example. The power supply control unit 31 may also be a combination of two or more of the CPU, the MPU, the GPU, the DSP, the ASIC, the PLD, and the FPGA. Furthermore, the power supply control unit 12 realizes various functions through execution of a software program stored in a memory of the power supply control unit 12 by a processor such as the CPU or the MPU.

The platform (main) 10 transmits and receives various signals. More specifically, the platform (main) 10 transmits and receives signals such as the POW_SW signal, the PC_S5_STATE # signal, the PC_S3_STATE # signal, the SUSSW # signal, and the PS_ON_PMU # signal. The 12V and the 11V are connected to the platform (main) 10. The POW_SW signal, the PC_S5_STATE # signal, and the PC_S3_STATE # signal are transmitted to and received from the processor 11. Further, the SUSSW # signal and the PS_ON_PMU # signal are transmitted to and received from the power supply control unit 12.

The processor 11 controls the POW_SW signal, the PC_S5_STATE # signal, and the PC_S3_STATE # signal, based on the power state of the platform (main) 10.

The power supply control unit 12 is an example of a second power supply control unit. The power supply control unit 12 controls the power state of the platform (main) 10. For example, the power supply control unit 12 shuts down the platform (main) 10 when the power supply control unit 31 requests a shutdown. More specifically, when the falling edge of the SUSSW # signal is detected while the platform (main) 10 is in the shutdown state, the power supply control unit 12 determines that the falling edge signifies an activation request. Then, the power supply control unit 12 activates the platform (main) 10. When the Low state of the SUSSW # signal is consecutively detected for a predetermined period of time while the platform (main) 10 is in the activated state, the power supply control unit 12 determines that the Low state signifies a forcible shutdown request. Then, the power supply control unit 12 forcibly shuts down the platform (main) 10. The predetermined period of time is, for example, five seconds but may be arbitrarily changed.

The platform (main) 10 generates a power source by using the 12V and the 11V. By the way, the SUSSW # signal is also used as a signal for activating the platform (main) 10. Specifically, when the PC_S5_STATE # is in the High state, that is, in a shutdown state, the power supply control unit 12 detects the falling edge of the SUSSW # signal as an activation request. Due to this, even when the power supply signal control unit 313 sets the SUSSW # signal to keep it in the Low state for a predetermined period of time in order to shut down the platform (main) 10, the power supply control unit 12 erroneously detects the falling edge of the SUSSW # signal as an activation request.

After inputting an operation of executing a normal shutdown, when a user keeps the power button 50 holding down in order to forcibly shut down without waiting for a start of the normal shutdown, the platform (main) 10 enters the shutdown state by the first (normal) shutdown operation. In brief, the PC_S5_STATE # enters the High state. In this case, a conventional power supply signal controller sets, based on the second (forcible) shutdown operation, the SUSSW # signal to be in the Low state for a predetermined period of time regardless of the power state of the platform (main). The power supply controller detects the falling edge of the SUSSW # signal at this time as an activation request. As a result, the power supply controller activates the platform (main). However, on the other hand, the platform (sub) is shut down due to the second (forcible) shutdown operation. This interaction in the conventional technique brings about a mismatch in power state within a distributed computer.

In contrast to above, the power supply signal control unit 313 according to the present embodiment maintains the High state of the SUSSW # signal when the platform (main) 10 is in the shutdown state while a forcible shutdown has been input. As a result, the power supply control unit 12 does not detect the falling edge of the SUSSW # signal and not activate the platform (main) 10. Therefore, the power supply signal control unit 313 can prevent the above-described mismatch in power state within the distributed computer 1.

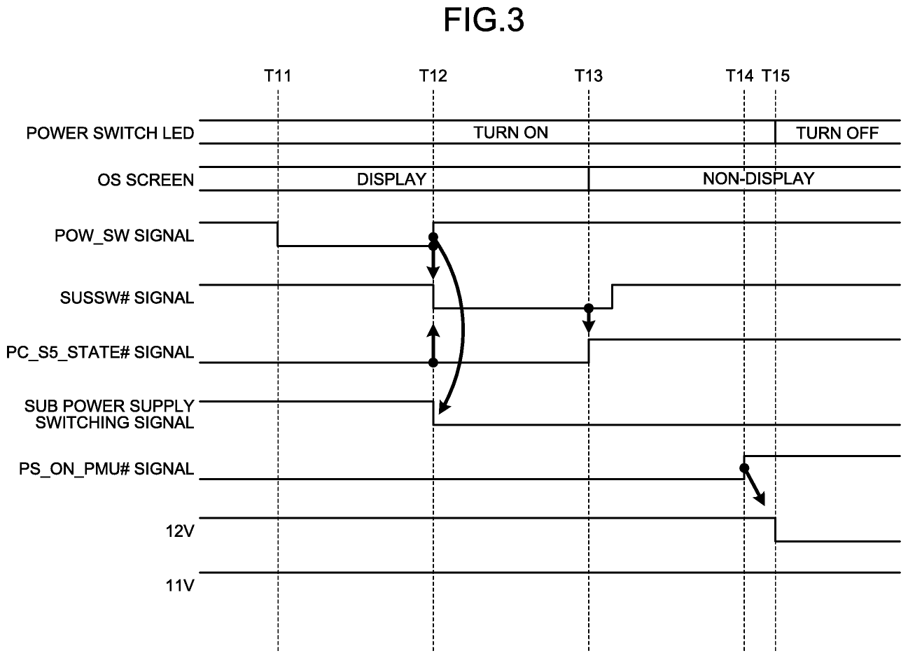

Next, the power supply control of the distributed computer 1 will be described with reference to timing charts illustrated in FIGS. 3 to 10.

FIG. 3 is a timing chart illustrating an example of power supply control processing for a case where a forcible shutdown operation is received.

For a period of time from T11 to T12 illustrated in FIG. 3, the power button 50 is kept to hold down for four seconds, so that the POW_SW signal is put in the Low state for the four seconds. In short, the operation input unit 311 receives a forcible shutdown operation.

At T12, since the forcible shutdown operation is received, the sub power supply switching signal enters the Low state.

At T12, since the PC_S5_STATE # signal is in the Low state, the monitoring unit 312 determines that the power state of the platform (main) 10 is in the activated state. In addition, at T12, since the PC_S5_STATE # signal is in the Low state, the power supply signal control unit 313 sets the SUSSW # signal to be in the Low state.

At T13, since a time of four seconds elapses after the SUSSW # signal enters the Low state, the platform (main) 10 normally terminates a firmware and shuts down. Then, the processor 11 sets the PC_S5_STATE # to be in the High state.

At T14, the PS_ON_PMU # enters the High state.

At T15, since the PS_ON_PMU # enters the High state, the PSU 40 shuts off the 12V power supply.

Then, the distributed computer 1 terminates power supply control processing for the case where a forcible shutdown operation is received.

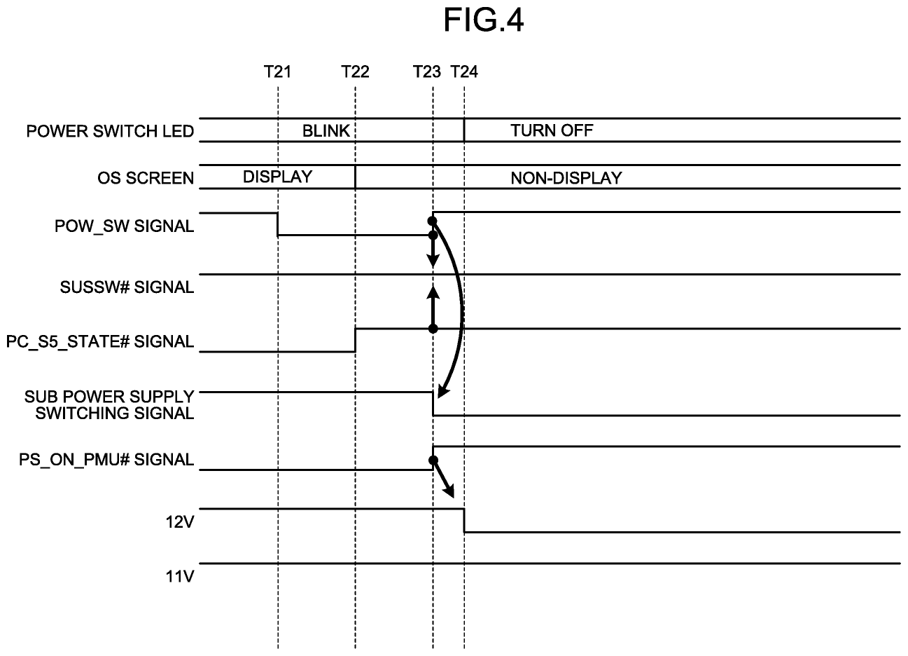

FIG. 4 is a timing chart illustrating an example of power supply control processing for a case where a forcible shutdown operation is received after shutdown processing is started by a shutdown operation of pushing the power button 50.

At T21 illustrated in FIG. 4, since the power button 50 is pushed, the POW_SW signal enters the Low state. Reception of an operation of executing forcible shutdown processing is started without waiting for a start of shutdown processing.

At T22, before the Low state of the POW_SW signal continues for four seconds, the platform (main) 10 is shut down due to a shutdown operation of pushing the power button 50. Thus, the processor 11 sets PC_S5_STATE # to be in the High state.

At T23, a time of four seconds elapses after the POW_SW signal enters the Low state. However, since the PC_S5_STATE # is in the High state, the power supply signal control unit 313 maintains the SUSSW # in the High state.

At T23, since the forcible shutdown operation is received, the sub power supply switching signal enters the Low state.

Further, at T23, the PS_ON_PMU # enters the High state.

At T24, since the PS_ON_PMU # enters the High state, the PSU 40 shuts off the 12V power supply.

Then, the distributed computer 1 terminates power supply control processing for the case where a forcible shutdown operation is received.

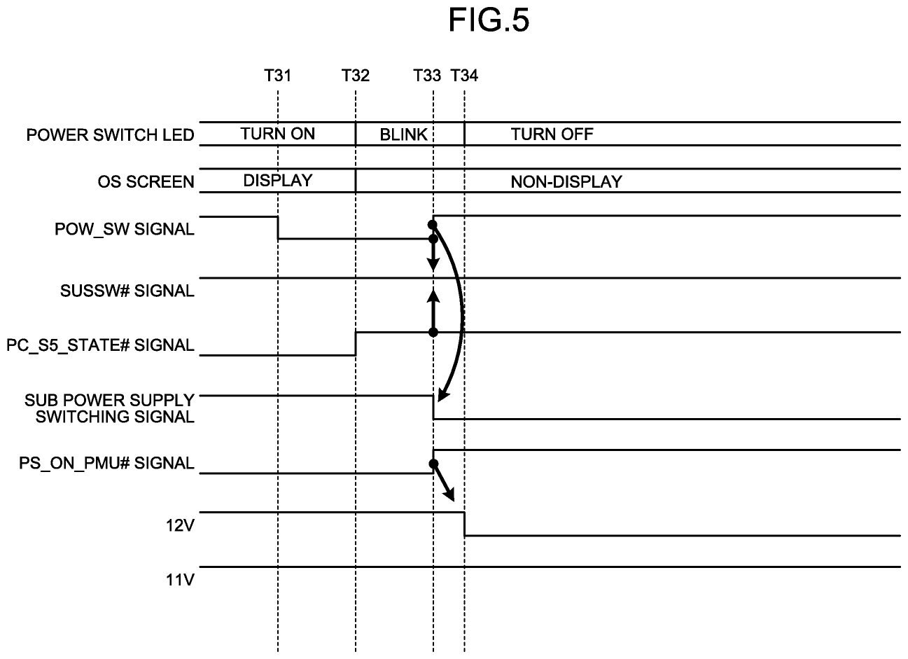

FIG. 5 is a timing chart illustrating an example of power supply control processing for a case where a forcible shutdown operation is received after shutdown processing is started by a shutdown operation received on an OS screen.

The timing chart illustrated in FIG. 5 is different from the timing chart illustrated in FIG. 4 in that the forcible shutdown operation is received after the shutdown processing is started by the shutdown operation received on the OS screen. While an operation of each signal is similar to one in the timing chart illustrated in FIG. 4, timings of turning on and blinking a power switch LED is different from those in FIG. 4.

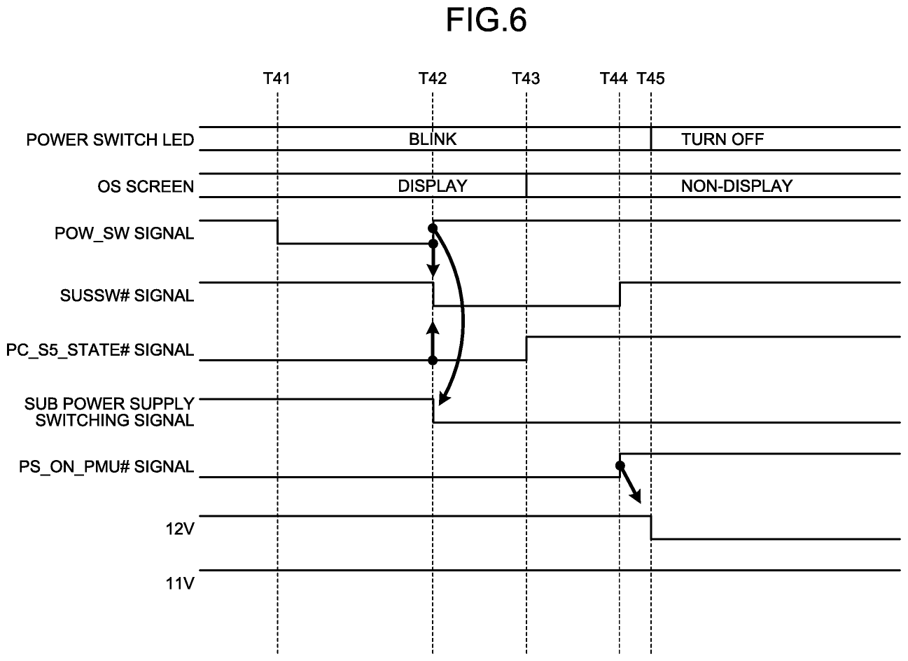

FIG. 6 is a timing chart illustrating an example of power supply control for a case where a forcible shutdown operation is received before shutdown processing by a shutdown operation of pushing the power button 50 is started.

For a period of time from T41 to T42 illustrated in FIG. 6, the power button 50 is kept to hold down for four seconds, so that the POW_SW signal is put in the Low state for the four seconds. In short, the operation input unit 311 receives a forcible shutdown operation.

At T42, since the forcible shutdown operation is received, the sub power supply switching signal enters the Low state.

At T42, since the PC_S5_STATE # signal is in the Low state, the monitoring unit 312 determines that the power state of the platform (main) 10 is in the activated state. Further, since the PC_S5_STATE # signal is in the Low state, at T42, the power supply signal control unit 313 sets the SUSSW # signal to be in the Low state.

At T43, before the Low state of the SUSSW # continues for four seconds, the power supply control unit 12 shuts down based on the shutdown operation of pushing the power button 50. Then, the processor 11 sets PC_S5_STATE # to be in the High state.

At T44, the PS_ON_PMU # enters the High state.

At T45, since the PS_ON_PMU # enters the High state, the PSU 40 shuts off the 12V power supply.

Then, the distributed computer 1 terminates power supply control processing for the case where a forcible shutdown operation is received.

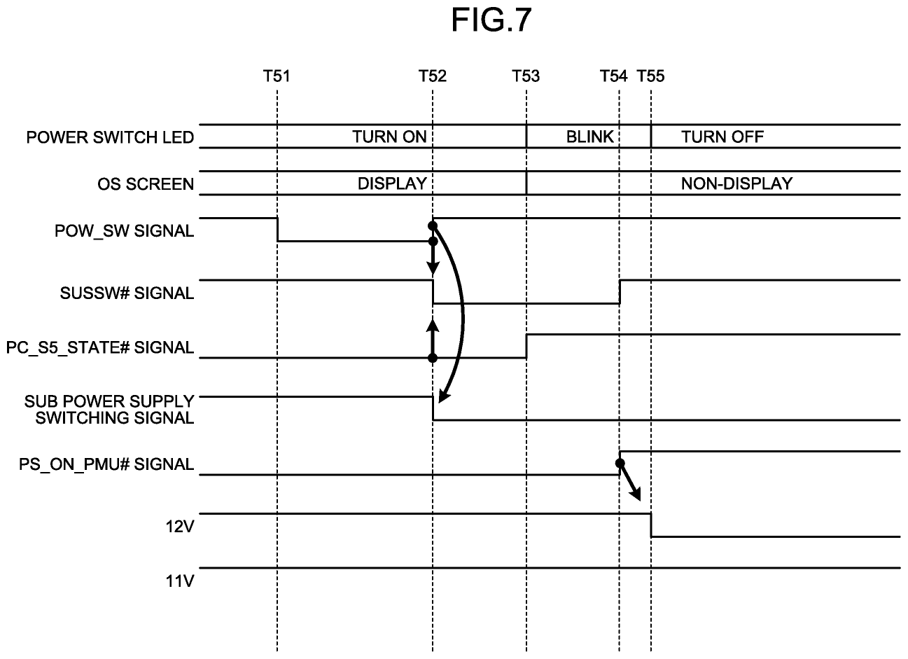

FIG. 7 is a timing chart illustrating an example of power supply control processing for a case where a forcible shutdown operation is received before shutdown processing by a shutdown operation received on an OS screen is started.

The timing chart illustrated in FIG. 7 is different from the timing chart illustrated in FIG. 6 in that the forcible shutdown operation is received after the shutdown processing is started by the shutdown operation received on the OS screen. While an operation of each signal is similar to one in the timing chart illustrated in FIG. 6, timings of turning on and blinking a power switch LED is different from those in FIG. 6.

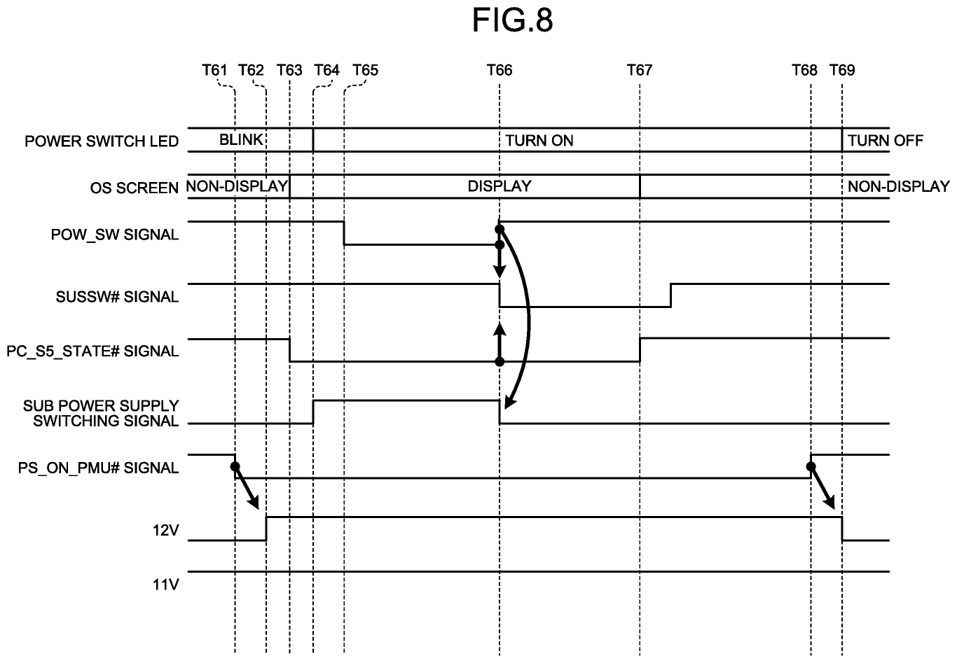

FIG. 8 is a timing chart illustrating an example of power supply control for a case where a forcible shutdown operation is received after starting up the distributed computer 1.

At T61, with the startup of the distributed computer 1, the PS_ON_PMU # enters the Low state.

At T62, since the PS_ON_PMU # enters the Low state, the PSU 40 supplies the 12V power.

At T63, with the startup of the distributed computer 1, the power supply control unit 12 sets the PC_S5_STATE # to be in the Low state.

At T64, with the startup of the distributed computer 1, the sub power supply switching signal enters the High state.

For a period of time from T65 to T66, the power button 50 is kept to hold down for four seconds, so that the POW_SW signal is put in the Low state for the four seconds. In short, the operation input unit 311 receives a forcible shutdown operation.

At T66, since the forcible shutdown operation is received, the sub power supply switching signal enters the Low state.

At T66, since the PC_S5_STATE # signal is in the Low state, the monitoring unit 312 determines that the power state of the platform (main) 10 is in the activated state. At T66, since the PC_S5_STATE # signal is in the Low state, the power supply signal control unit 313 sets the SUSSW # signal to be in the Low state.

At T67, since a time of four seconds elapses after the SUSSW # signal enters the Low state, the power supply control unit 12 shuts down the platform (main) 10. Then, the processor 11 sets the PC_S5_STATE # to be in the High state.

At T68, the PS_ON_PMU # enters the High state.

At T69, since the PS_ON_PMU # enters the High state, the PSU 40 shuts off the 12V power supply.

Then, the distributed computer 1 terminates power supply control processing for the case where a forcible shutdown operation is received.

As described above with reference to FIGS. 4 to 7, when a forcible shutdown operation is received after receiving an operation of shutting down the distributed computer 1, the power supply control unit 31 requests, on a condition that the power state of the platform (main) 10 is activated, a shutdown of the platform (main) 10. In other words, the power supply control unit 12 of the platform (main) 10 receives a shutdown request on a condition that the power state of the platform (main) 10 is activated. Thus, since the distributed computer 1 does not erroneously detect a power supply operation during shutdown as a startup request, it is possible to prevent the power state from being different for each of the platform (main) 10 and the platforms (sub) 20.

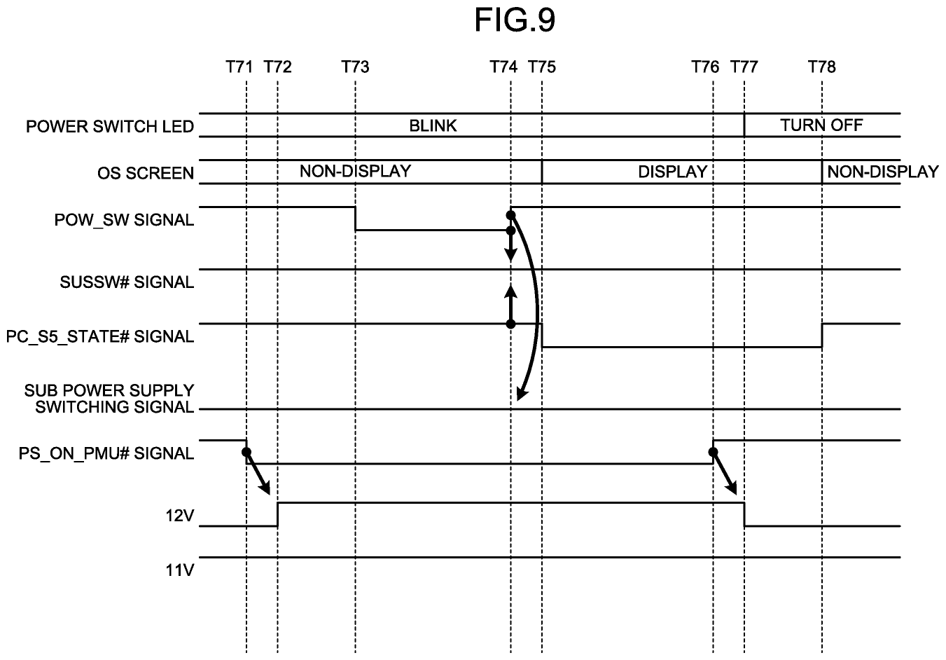

FIG. 9 is a timing chart illustrating an example of power supply control processing for a case where a forcible shutdown operation is received after a startup operation of the distributed computer 1 and before the platform (main) 10 is activated.

At T71, with the startup of the distributed computer 1, the PS_ON_PMU # enters the Low state.

At T72, since the PS_ON_PMU # enters the Low state, the PSU 40 supplies the 12V power.

For a period of time from T73 to T74, the power button 50 is kept to hold down for four seconds, so that the POW_SW signal is put in the Low state for the four seconds. In short, the operation input unit 311 receives a forcible shutdown operation.

At T74, since the forcible shutdown operation is received, the sub power supply switching signal is maintained in the Low state. In other words, the platforms (sub) 20 are not activated.

At T75, with the startup of the distributed computer 1, the power supply control unit 12 sets the PC_S5_STATE # to be in the Low state.

At T76, the PS_ON_PMU # enters the High state due to timeout.

At T77, since the PS_ON_PMU # enters the High state, the PSU 40 shuts off the 12V power supply.

Since the PC_S5_STATE # is in the Low state in spite of the fact that the 12V is not supplied, the processor 11 shuts down at T78. In other words, since the activated state cannot be maintained by the 11V, the processor 11 shuts down.

As described above, the distributed computer 1 terminates power supply control processing for the case where a forcible shutdown operation is received.

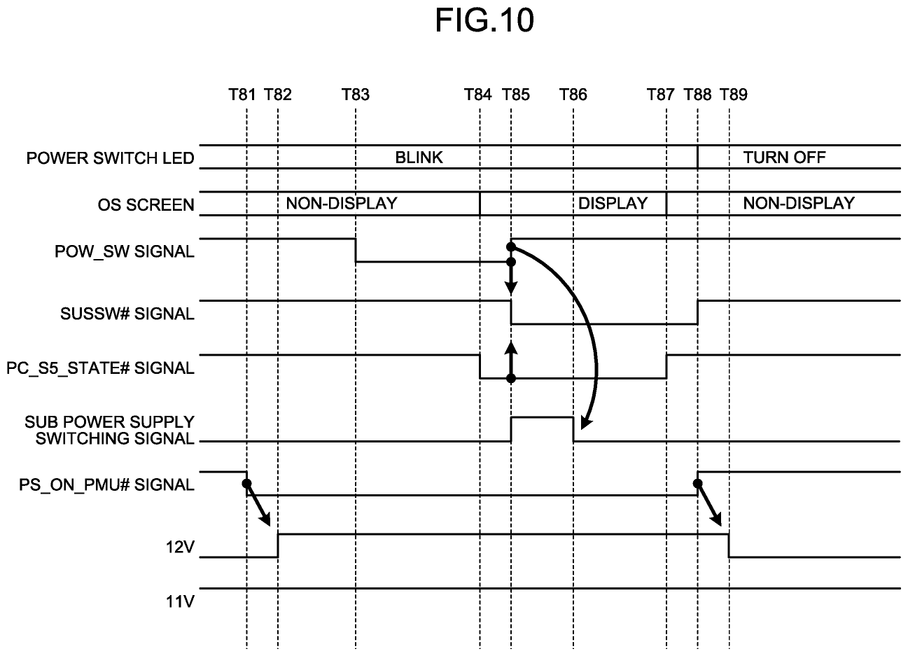

FIG. 10 is a timing chart illustrating an example of power supply control processing for a case where a forcible shutdown operation is received after a startup operation of the distributed computer 1 and before the platforms (sub) 20 are activated.

At T81, with the startup of the distributed computer 1, the PS_ON_PMU # enters the Low state.

At T82, since the PS_ON_PMU # enters the High state, the PSU 40 supplies the 12V power.

At T83, the power button 50 is pushed, so that the POW_SW signal is set to be in the Low state.

At T84, the power supply control unit 12 sets, with the startup of the distributed computer 1, the PC_S5_STATE # to be in the Low state.

At T85, a time of four seconds elapses after the power button 50 is kept to hold down. In short, the operation input unit 311 receives a forcible shutdown operation.

At T85, since the PC_S5_STATE # signal is in the Low state, the monitoring unit 312 determines that the power state of the platform (main) 10 is in the activated state. In addition, at T85, since the PC_S5_STATE # signal is in the Low state, the power supply signal control unit 313 sets the SUSSW # signal to be in the Low state.

Further, at T85, with the startup of the distributed computer 1, the sub power supply switching signal enters the High state.

At T86, since the forcible shutdown operation is received, the sub power supply switching signal enters the Low state.

At T87, since a time of four seconds elapses after the SUSSW # signal enters the Low state, the platform (main) 10 shuts down. Then, the processor 11 sets the PC_S5_STATE # to be in the High state.

At T88, the PS_ON_PMU # enters the High state.

At T89, since the PS_ON_PMU # enters the High state at T87, the PSU 40 shuts off the 12V power supply.

Then, the distributed computer 1 terminates power supply control processing for the case where a forcible shutdown operation is received.

As illustrated in FIGS. 8 to 10, when a forcible shutdown operation is received after receiving an operation of starting up the distributed computer 1, the power supply control unit 31 requests, on a condition that the power state of the platform (main) 10 is activated, a shutdown of the platform (main) 10. In other words, the power supply control unit 12 of the platform (main) 10 receives a shutdown request on a condition that the power state of the platform (main) 10 is activated. Thus, since the distributed computer 1 does not erroneously detect a power supply operation during shutdown as a startup request, it is possible to prevent the power state from being different for each of the platform (main) 10 and the platforms (sub) 20.

As described above, in the distributed computer 1 according to the present embodiment, the platform (main) 10 and the plurality of platforms (sub) 20 are connected via the PCIe bridge 30. The power supply control unit 31 shuts down the platforms (sub) when receiving a forcible shutdown caused by keeping the power button 50 holding down for a predetermined period of time or longer. In addition, when the operation of forcibly shutting down the distributed computer 1 is received, the power supply control unit 31 requests, on a condition that the power state of the platform (main) 10 is activated, a shutdown of the platform (main) 10. Then, upon receiving the shutdown request, the power supply control unit 12 of the platform (main) 10 shuts down. In this way, the power supply control unit 12 of the platform (main) 10 receives a shutdown request on a condition that the power state of the platform (main) 10 is activated. Thus, the distributed computer 1 does not erroneously detect a power supply operation during shutdown as a startup request. Therefore, it is possible to prevent the power state from being different for each of the platform (main) 10 and the platforms (sub) 20.

More specifically, when the forcible shutdown caused by keeping the power button 50 holding down for a predetermined period of time or longer is received, the power supply control unit 31 changes the SUSSW # signal to the Low state and requests a shutdown of the platform (main) 10, on a condition that the platform (main) 10 is activated based on the PC_S5_STATE # signal. In other words, when a forcible shutdown is received, the power supply control unit 31 ignores the forcible shutdown for the reason that the platform (main) 10 has already been shut down. Therefore, the power supply control unit 12 of the platform (main) 10 does not erroneously detect the forcible shutdown as a startup request, so that the platform (main) 10 is not activated. Thus, the distributed computer 1 can prevent the power state from being different for each of the platform (main) 10 and the platforms (sub) 20.

In the embodiment described above, while PCIe has been described as an example of a bus (e.g., an expansion bus) of each section or an I/O interface of the distributed computer 1, the bus or the I/O interface is not limited to PCIe. For example, the bus or the I/O interface of each section may be any technique that can transfer data between a device (peripheral controller) and a processor by a data transfer bus. The data transfer bus may be a general-purpose bus that can transfer data at a high speed in a local environment (e.g., one system or one device) provided in one housing, for example. The I/O interface may be either a parallel interface or a serial interface.

In the case of serial transfer, the I/O interface may have a configuration that is capable of executing point-to-point connection and data transfer on a packet basis. In the case of serial transfer, the I/O interface may have a plurality of lanes. A layer structure of the I/O interface may include a transaction layer that generates and decodes a packet, a data link layer that detects errors, for example, and a physical layer that converts between serial and parallel. In addition, the I/O interface may include, for example, a root complex, the highest level in a hierarchy with one or more ports, an endpoint or an I/O device, a switch for increasing ports, and a bridge that converts a protocol. The I/O interface may multiplex and transmit data to be transmitted and a clock signal using a multiplexer. In this case, a receiving side may separate the data and the clock signal with a demultiplexer.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a plurality of information processing devices; and
a relay device that comprises a plurality of buses to which the information processing devices are connected, wherein
the relay device requests a main information processing device among the information processing devices to execute a shutdown once the relay device receives an operation of forcibly shutting down the information processing system, the shutdown being requested on a condition that a power state of the main information processing device is activated, and
the main information processing device shuts down the main information processing device once the main information processing device receives the request for the shutdown.

2. The information processing system according to claim 1, wherein the relay device carries out the request for the shutdown once the forcible shutdown operation is received after receiving an operation of shutting down the information processing system.

3. The information processing system according to claim 1, wherein the relay device carries out the request for the shutdown once the forcible shutdown operation is received after receiving an operation of activating the information processing system.

4. The information processing system according to claim 1, wherein the relay device:
receives a power supply operation signal representing an operation of changing a power state of the information processing system;
monitors a power state signal representing the power state of the main information processing device;
determines, when the power supply operation signal is valid for a predetermined period of time, that the operation of forcibly shutting down is received;
determines, based on the power state signal, whether the condition is satisfied; and
carries out the request for the shutdown by setting a state of a power supply control signal to shut down the main information processing device, the power supply control signal being a signal to be given from the relay device to the main information processing device.

5. A power supply control method implemented by a distributed computer in which a plurality of information processing devices are connected to a relay device over a plurality of buses, the method comprising:
requesting, from the relay device, a main information processing device among the information processing devices to execute a shutdown once the relay device receives an operation of forcibly shutting down the distributed computer, the shutdown being requested on a condition that a power state of the main information processing device is activated; and
shutting down the main information processing device once the main information processing device receives the request for the shutdown.

6. The power supply control method according to claim 5, wherein the requesting from the relay device is carried out once the forcible shutdown operation is received after receiving an operation of shutting down the distributed computer.

7. The power supply control method according to claim 5, wherein the requesting from the relay device is carried out once the forcible shutdown operation is received after receiving an operation of activating the distributed computer.

8. The power supply control method according to claim 5, further comprising:
receiving a power supply operation signal representing an operation of changing a power state of the distributed computer;
monitoring a power state signal representing the power state of the main information processing device;
determining, when the power supply operation signal is valid for a predetermined period of time, that the operation of forcibly shutting down is received; and
determining, based on the power state signal, whether the condition is satisfied,
wherein the requesting from the relay device is carried out by setting a state of a power supply control signal to shut down the main information processing device, the power supply control signal being a signal to be given from the relay device to the main information processing device.
